(19) United States
(12) Patent Application Publication
(10) Pub. No.: US 2002/0167629 A1
(43) Pub. Date: Nov. 14, 2002

(54) Sunlight readable display with reduced ambient specular reflection

(76) Inventor: Randall D. Blanchard, San Diego, CA (US)

Correspondence Address: Michael G. Fletcher, Fletcher, Yoder & Van Someren, P.O. Box 692289, Houston, TX, 77269-2289, US

(21) Appl. No.: 09/853,276

(22) Filed: May 11, 2001

(51) Int. Cl. G02F 1/1335

(52) U.S. Cl. 349/112

(57) ABSTRACT

The present technique relates to a method and apparatus for providing a display image that is readable under high ambient light conditions. The technique includes the use of an anti-glare surface with a significant surface texture. This surface will accommodate the deposition of an effective thin film anti-reflective optical coating. The technique provides a diffusive layer configured to diffuse light within the diffusive layer, and provides a bond between display layers to enhance performance of the display.

### BACKGROUND OF THE INVENTION

1. Field of the Invention

This invention relates generally to display screens and, more particularly, to a method and apparatus for controlling the image quality of a display screen used in relatively high ambient brightness.

2. Description of the Related Art

This section is intended to introduce the reader to various aspects of art that may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Liquid crystal displays, which are commonly known as LCD displays, have been used for a number of years in a wide variety of applications. LCD displays are probably most commonly used for small digital readouts, such as the digital displays found in watches and calculators. The area of such LCD displays is typically no larger than one square inch. As most people who own a watch or calculator having an LCD display are aware, LCD displays must be illuminated for viewing in dim lighting. Accordingly, most devices having relatively small LCD displays include a light source that effectively illuminates the display so that the user of the device can read the display in dimly lit environments.

LCD displays have become increasingly larger in size and, thus, are being used in applications much more complex than providing a simple digital readout. For example, LCD displays are currently a popular choice for desktop computers, portable computers, personal information organizers, point-of-sale (POS) terminals, interactive kiosks, and the like. The area of these relatively large displays is typically greater than five square inches, and these displays may be larger than 100 square inches. These displays are typically illuminated using one or more lamps in an edge lit backlight design. For displays being used in high ambient light conditions, it is desirable to have a sufficient brightness and uniformity to allow a user to view text and graphics effortlessly.

To address this problem, a direct backlight using multiple lamps replaces the edge lit backlight. This design can provide over 5 times the display image brightness of an edge lit LCD. The display may also include an anti-glare front surface. These types of LCD displays also suffer from various other image quality concerns, such as non-uniformity, glare, reflections, lack of clarity, and a variety of coloration problems such as color separation (e.g., specking artifacts, or rainbow effect that moves with eye movement). Many of these concerns, including lighting and image quality, are more apparent in an outdoor atmosphere (e.g., sunlight, rain, hot and cold temperatures, pollution, etc.), where many LCD displays are now being used.

Accordingly, the present invention may address one or more of the matters set forth above.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, there is provided a display. The display may include a display screen, a transparent panel having a backside and an anti-glare front surface configured to diffuse ambient light, and a bulk diffuser disposed between surfaces of the display screen and the backside. The bulk diffuser, which is configured to diffuse image light, is bonded to at least one of the display screen and the transparent panel.

In accordance with another aspect of the present invention, there is provided a method for manufacturing a display having a display screen. The method may include the acts of positioning a bulk diffuser between the display screen and an anti-glare front layer, and bonding the bulk diffuser to at least one of the anti-glare front layer and the display screen. The bulk diffuser includes a diffusive material configured to scatter light within the diffusive material.

In accordance with another aspect of the present invention, there is provided a method of forming a display. The method may include the acts of flowing a bond material onto a side portion of a bond surface of a first layer of a plurality of display layers, aligning a feature of a second layer of the plurality of display layers with a feature of the first layer to form a junction, rotating and pressing the second layer onto the first layer starting from the junction and proceeding evenly across the second layer to form a substantially uniform bond layer of the bond material between the first and second layers, and curing the bond material.

### BRIEF DESCRIPTION OF THE DRAWINGS

The foregoing and other advantages of the invention will become apparent upon reading the following detailed description and upon reference to the drawings in which:

FIG. 1 is a front view of an LCD display;

FIG. 2 is a cross-sectional view of the LCD display of FIG. 1 taken along line 2-2 illustrating an exemplary illumination system of the present technique;

FIG. 3 is a cross-sectional view illustrating a backend portion of an alternate illumination system of the present technique;

FIGS. 4 and 5 are cross-sectional views illustrating an exemplary forward portion of the illumination system of the present technique; and

FIG. 6 is a flow chart of an exemplary bonding technique for the illumination systems of the present technique.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

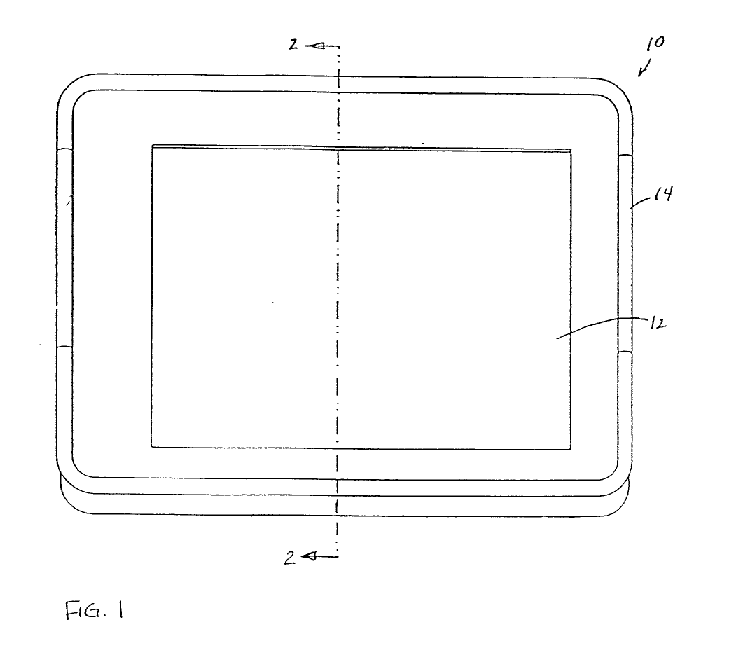

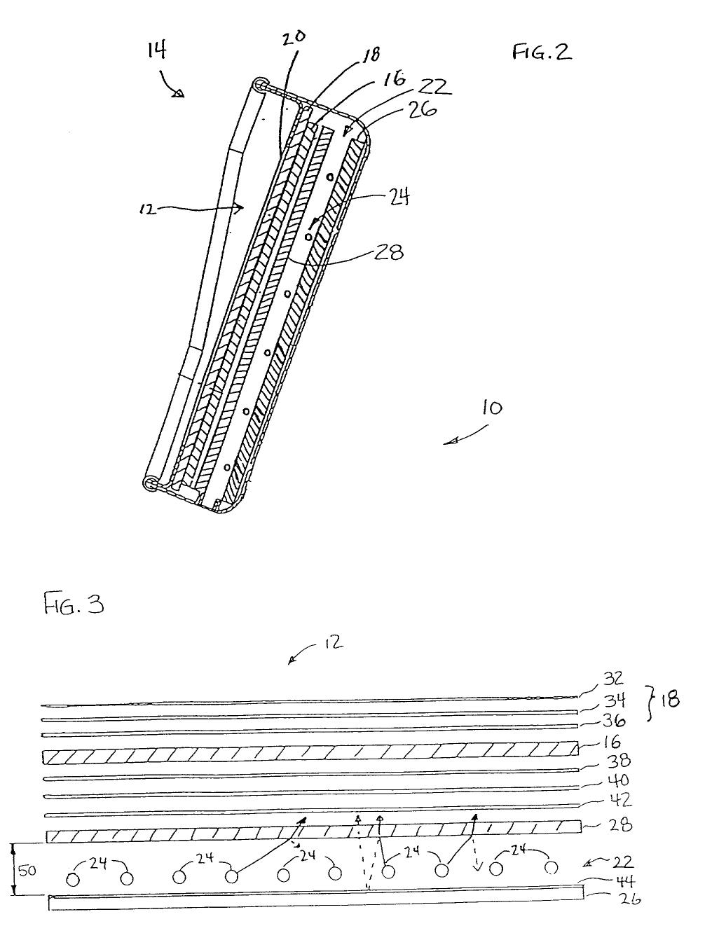

Turning now to the drawings, and referring initially to FIGS. 1 and 2, a device having an illuminated LCD display is illustrated and generally designated by a reference numeral 10. The device 10 may be a computer, although a variety of other devices, such as cellular telephones, personal organizers, touch screens, and the like, may also benefit from the teachings disclosed herein. The device 10 includes an LCD display 12 housed within a display module 14. The LCD display 12 includes a liquid crystal element 16, which responds to appropriate electrical inputs to display the desired information. Since the manner in which the liquid crystal element 16 operates is well known in the art, details of such operation are not provided in this disclosure.

The front of the liquid crystal element 16 is protected by a window assembly 18, which is normally made of glass or plastic. The window assembly 18 also may include a variety of films, layers and textures to facilitate the desired optical and illumination characteristics of the LCD display 12. The window assembly 18 is mounted within an opening 20 on a front portion of the display module 14 such that users may clearly view the information displayed by the liquid crystal element 16. A specific mounting structure is not illustrated because it should be understood that various mounting arrangements may exist depending on the type of application in which the LCD display 12 is intended to be used. For example, if the display 12 is to be used in a harsh environment, the mounting structure may be shock resistant and include seals to prevent water and dirt from entering the display module 14. The mounting structure may also have a variety of electronic and computer components, such as in a computer system.

A liquid crystal element 16 is often illuminated by a back light structure 22 disposed behind the liquid crystal element 16, as illustrated in FIG. 2. In the exemplary embodiment of FIG. 2, the back light structure 22 comprises one or more light members 24 (e.g., a cylindrical or elongated lamp, or a U-shaped lamp) and a reflector panel 26. The light member 24 provides light in all directions around its longitudinal axis, thereby transmitting light partially toward the liquid crystal element 16 and partially toward the reflector panel 26. Although some light is transmitted laterally, the reflector panel 26 receives light directed away from the liquid crystal element 16, and reflects a substantial portion of the light back toward the liquid crystal panel 16 to increase the illumination and efficiency of the back light structure 22. In this exemplary embodiment, the back light structure 22 is configured such that a substantial amount of the light provided by the light member 24 is transmitted toward a diffuser panel 28, either directly from the light member 24 or reflected off of the reflector panel 26. The diffuser panel 28 then uniformly distributes the light across its area in order to illuminate the liquid crystal element 16 uniformly.

FIG. 3 is a cross-sectional view of an alternate embodiment of the LCD display 12 having a plurality of layers/panels to enhance the consistency and luminosity of the display viewable by the user. As illustrated, the LCD display 12 has the window assembly 18, which includes an antireflective layer 32, an anti-glare layer 34, and a transparent screen layer 36, disposed adjacent the liquid crystal display 16, brightness enhancement films (BEF) 38, 40 and 42, the diffuser panel 28, and the back light structure 22.

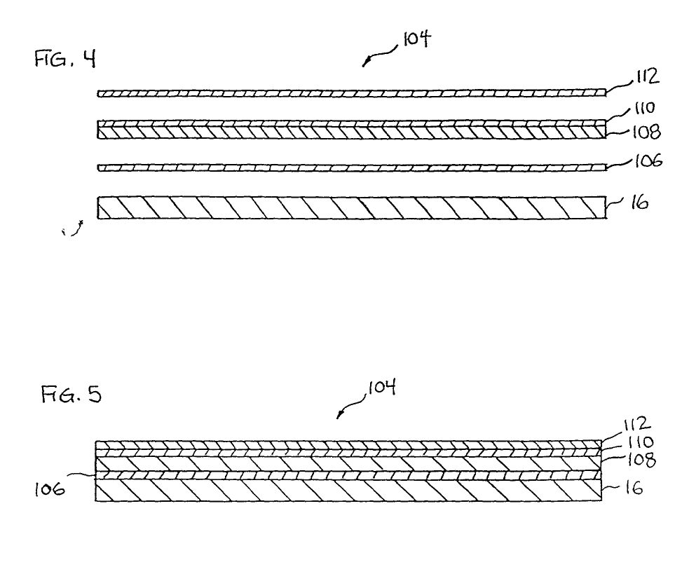

The optical and lighting qualities of the LCD display 12 are enhanced by the use of one or more anti-glare and anti-reflective layers 34 and 32, which may be placed over the transparent screen layer 36. The anti-glare layer 34, or matte surface, is provided to reduce the specular (mirror) reflected ambient image. The anti-reflective layer 32, or thin film optical coating, is provided to reduce the total front surface reflection. In the exemplary embodiment, one or more of these layers 32, 34 and 36 may be bonded to the liquid crystal display 16. For example, a glass panel can be provided with a chemically etched anti-glare and anti-reflective coated surface, which can then be bonded to the liquid crystal display 16, as discussed in detail with reference to FIG. 4 for instance. The materials, including the bonding materials, also may enhance optical characteristics by index matching the various layers and panels (i.e., matching the index of refraction for the various panels). For example, the anti-reflective coating can be index matched to the transparent screen layer 36 to provide low levels of reflectivity, such as in the range of 0.25 to 1.00%. In addition to enhancing the reflection properties of the transparent screen layer 36, the coatings also may include a “hot mirror” capability to reflect solar energy outside the visible spectrum (i.e., infrared and ultraviolet light) to protect the underlying elements of the LCD display 12. Suitable anti-reflective materials may include, for example, silicon dioxide or magnesium fluoride.

The illumination and optical characteristics also may be enhanced by other panels and films disposed about the liquid crystal display 16. For example, brightness enhancement films can be disposed/bonded adjacent the diffuser panel 28. The brightness enhancement films 38, 40 and 42 are provided to enhance the characteristics of the light transmitted from the diffuser panel 28. For example, the brightness enhancement films 38, 40 and 42 may be configured for pre-polarizing light, for bending light vertically, and for bending light horizontally, respectively. In this exemplary embodiment, one or more of the brightness enhancement films 38, 40 and 42 may have microprisms for scattering and reflecting light. Also, one or more of the brightness enhancement films 38, 40 and 42 may be reflective polarizer films or absorptive polarizer films. In the present technique, a reflective polarizer (or pre-polarizer) may be used, as opposed to an absorptive polarizer, to facilitate light transmission through the display. An absorptive polarizer transmits less than half of the light through the display (e.g., 53% absorbed), while a reflective polarizer may advantageously increase brightness of the display (e.g., by 30%). Accordingly, the brightness enhancement films 38, 40 and 42 enhance scattering and light distribution to procure uniform and brighter illumination of the LCD display 12. Other arrangements, types and numbers of brightness enhancement films can also be applied within the scope of the present technique. Moreover, one or more of the brightness enhancement films can be bonded to the liquid crystal display 16, to the diffuser panel 28, and/or to one another. As noted above, the various display layers may be index matched (i.e., index of refraction) to enhance the efficiency and performance of the LCD display 12.

The surface properties of the reflector panel 26 also may impact the effectiveness of the back light structure 22. In this exemplary embodiment, the reflector panel 26 has a reflective surface 44 for scattering and reflecting light from the light members 24 and retro-reflected light from the diffuser panel 28 (and other light films), as illustrated by the solid and dashed arrows, respectively. The reflective surface 44 may comprise a variety of reflective materials such as a matte reflective vinyl, paint or Teflon coated mesh. For example, the reflective surface 44 may comprise a diffuse white or silver material with a high reflectance. Accordingly, light rays striking the reflective surface 44 diffusely reflect toward the display layers (e.g., the diffusion panel 28, BEFs, etc.).

The back light structure 22 is offset from the diffuser panel 28 at an offset distance 50 (e.g., ½ to 1 inch), which may significantly impact the overall lighting performance of the LCD display 12. At a desired offset distance 50, the light rays may be more efficiently transferred to the diffuser panel 28 and through the layers of the LCD display 12 for a more uniform and efficient illumination of the LCD display 12.

As illustrated by the solid arrows in FIG. 3, the light rays emitted by the light members 24 travel toward the diffuser panel 28 either directly from the light members 24 or reflected off of the reflector panel 26. Upon reaching the diffuser panel 28, a portion of the light rays travels through the diffuser panel 28 at an angle of refraction corresponding to the material and surface properties of the diffuser panel. However, the remaining portion of the light rays (i.e., retro-reflected light rays), as indicated by the dashed arrows, reflects off the diffuser panel 28 (and other display layers) and backwardly to the back light structure 22. The reflective surface 44 of the reflector panel 26 then reflect these retro-reflected light rays toward the diffuser panel 28 (and subsequent display layers) at a different angle and location. Accordingly, the reflective surface 44 facilitates the distribution and transfer of light rays toward the diffuser panel 28, and subsequent display layers, to facilitate substantially uniform illumination of the display. Moreover, the reflective surfaces 44 may have diffusive characteristics (e.g., a diffuse white surface) to scatter and depolarize the light rays and to cause further distribution of the light.

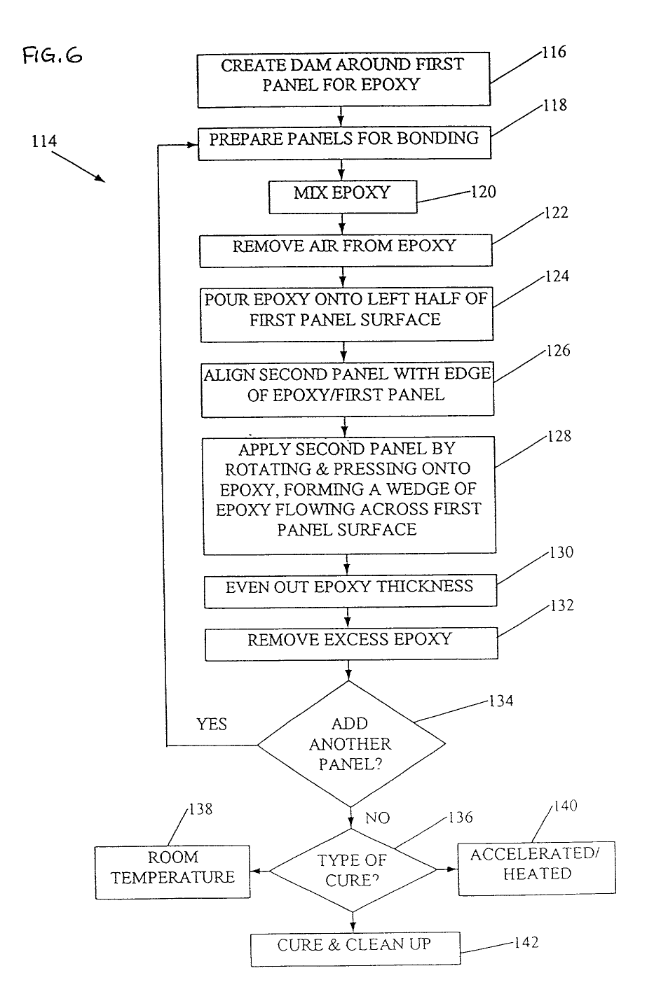

As described with reference to FIGS. 4-6, the present technique also may include a bulk diffuser and a bonding technique for the display. FIG. 4 is a partial cross-sectional view illustrating layers of an exemplary front portion 104 of the LCD display 16 prior to assembly, while FIG. 5 illustrates the front portion 104 after assembly according to the bonding process of FIG. 6. As illustrated in FIGS. 4 and 5, the front portion 104 comprises the liquid crystal display 16, a diffuser sheet 106, a transparent panel 108 (e.g., a glass or plastic panel), an anti-glare layer 110, and an anti-reflective layer 112. As discussed above, the anti-glare layer 110 reduces specular (mirror) reflections, and the anti-reflective layer 112 reduces the total front surface reflection. For the present technique, the anti-glare layer 110 may be an etched (matte) surface of the transparent panel 108, and the anti-reflective layer 112 may be an optical coating over the etched (matte) surface.

The anti-glare layer 110 can more effectively reduce specular reflections with a course etch, yet a course etch also reduces clarity or sharpness of the image. Variations in thickness, such as from etching, also cause undesirable optical interference or color separation (e.g., a micro pattern of color separation of the image light, or “speckling” artifacts). These undesirable effects decrease as the degree of etching is reduced (e.g., a finer etch), yet a finer etch also reduces the desired impact on ambient light diffusion (e.g., the effectiveness of the anti-glare layer 110). In the present technique, the anti-glare layer 110 can be chemically etched, mechanically ground, molded, or otherwise formed into the transparent panel 108, while a variety of other surface texturing techniques may be utilized depending on the desired coarseness of the matte surface. A ground-glass surface provides a relatively fine matte surface, as compared to other techniques. The anti-glare layer 110, which is configured to diffuse ambient light, may comprise a variety of coatings, films, and textured surfaces to enhance the lighting and optical performance of the display.

Accordingly, the present technique may comprise the act of providing the diffuser sheet 106 to complement the anti-glare layer 110 and to reduce the undesirable optical and lighting interferences and degradation caused by the surface texture and other characteristics of the anti-glare layer 110. The diffuser sheet 106 scatters (or diffuses) the image light prior to the anti-glare layer 110, thereby altering the distribution of light path lengths and scattering the collimated light from the backlight structure to facilitate the use of a more diffuse anti-glare layer 110. The altered characteristics of the light passing through the diffuser sheet 106 improves the overall performance of the display by reducing the undesirable effects (e.g., color separation) of the more diffuse anti-glare layer 110 (e.g., coarse texture). Thus, the present technique may include the act of modifying the anti-glare layer 110 to interact with the diffuser sheet 106 to provide a desired, or optimal, image quality and ambient light reflection for use in high brightness environments (e.g., outdoors). The optical characteristics of the display are further enhanced by bonding the diffuser sheet 106 into the display to provide a distribution of path lengths of the image light through the diffuser without the undesirable optical and lighting effects of surface textures and irregularities. Also, an index-matched bond material (i.e., the index of refraction is matched to the adjacent display layers) may be used to facilitate the passage of light through the display layers and to improve the overall optical performance of the display.

Accordingly, the present technique may provide a multi-layered structure with the diffuser sheet 106 disposed behind the anti-glare layer 110, as illustrated in FIG. 4. In this exemplary embodiment, the diffuser sheet 106 is a “bulk” diffuser, which utilizes a diffuser material to provide internal scattering rather than the surface scattering provided by etching. For example, the diffuser sheet 106 may include a sheet of Clarex (Astra Products, Inc., Baldwin, N.Y., USA). Although the degree of diffusion varies with thickness and material utilized for the diffuser sheet 106, the diffuser sheet 106 may advantageously have a thickness of less than 1 mm, or more advantageously, less than 0.5 mm. For example, the present technique may utilize a 0.2 mm or 0.3 mm sheet of Clarex (e.g., Clarex DR-93C, 0.3 mm) to facilitate a relatively small amount of diffusion and a high degree of light transmission (e.g., over 80% or 90% light transmission). Accordingly, the diffuser sheet 106 of the present technique can transmit over 80 or 90 percent of the light, and can advantageously transmit 90 to 95 percent of the light for a relatively thin sheet of Clarex in the proximity of 0.2 mm (e.g., 93% for a 0.2 mm sheet). In this configuration, the diffuser sheet 106 scatters (or diffuses) the image light prior to the anti-glare layer 110 (e.g., etched surface), facilitating the application of a more diffuse anti-glare layer 110 by reducing the undesirable optical and lighting effects (e.g., color separation or speckling artifacts) caused by the more diffuse anti-glare layer 110 (e.g., a more coarse surface texture). Unlike the anti-glare layer 110, the diffuser sheet 106 does not cause optical interference (e.g., color separation) due to surface and thickness variations. Moreover, the undesirable effects of the anti-glare layer, such as color separation, are significantly reduced while also enhancing the performance of the anti-glare layer to reduce the specular reflection (glare). The image and lighting qualities are further enhanced by bonding the layers and panels together with an index matched material, such as a two-part optical quality epoxy. The resulting display has exceptional sunlight readable performance.

FIG. 6 is a flow chart of an exemplary bonding technique 114, which may be used for bonding the diffuser sheet 106 to the front portion 104 or for bonding any other display layers (e.g., the display layers illustrated in FIGS. 2-3 and 4-5). Bonding the various layers of the display is desirable for many reasons, such as for reducing the optical Fresnel reflections caused as light travels through gaps between, and surfaces of, the various layers. By providing an index-matched bond, the light travels more directly through the various layers with less reflectance. For example, the diffuser sheet 106 can be bonded to the liquid crystal display 16 and to the transparent panel 108, making the front portion 104 a one-piece unit for the LCD display 12. The bonding technique 114 may be utilized for initial manufacturing of an LCD display or computer system and, also, for retrofitting the diffuser sheet 106 to an existing LCD display or computer system. Accordingly, the bonding technique provides an exemplary front portion 104 for the LCD display 12, as illustrated in FIGS. 4 and 5. The bonding technique can also be used for bonding other layers and panels, such as those illustrated in FIG. 3.

If the bonding technique 114 is applied to an existing LCD display 12 (e.g., a 12.1″ or 20.1″ LCD display), then the display housing can be disassembled to gain access to the liquid crystal display 16 and surrounding films, layers, and panels. For example, an outside frame may be removed to allow removal of the transparent panel 108 (e.g., a glass or plastic panel), the anti-glare layer 110, and the anti-reflective layer 112, leaving the liquid crystal display 16 exposed for the bonding technique. The liquid crystal display 16 can also be removed from the housing if doing so would make it easier to effectively carry out the bonding technique for the liquid crystal display 16.

Accordingly, the bonding technique 114 may comprise providing a container and creating a dam (block 116) to contain the epoxy (e.g., an optical grade) while bonding first and second panels. For example, a ⅛″ thick foam tape can be applied around the perimeter of the first panel (e.g., the liquid crystal display 16) to contain the epoxy and to help maintain a uniform bond thickness during the bonding technique (e.g., to allow the epoxy to spread and even out, yet maintaining sufficient thickness at the edges). The dam also isolates the epoxy from the mounting perimeter and adjacent components to prevent distortions and mechanical stresses caused by interaction with the mounting perimeter and adjacent components. The dam should be large enough to allow the subsequent layers/panels (i.e., the diffuser sheet 106, the transparent panel 108, the anti-glare layer 110 and the anti-reflective layer 112) to fit inside the dam for bonding. If any preparation is required, such as preparing the panels for bonding (block 118), it should be done before mixing the epoxy (block 120). For example, the bonding technique 114 may comprise cleaning the surface of the panels (e.g., the liquid crystal display 16), masking delicate or otherwise critical surfaces (e.g., the matte AR coated transparent panel 108), and cleaning or covering other areas. After or during preparation, the epoxy is mixed (block 120) and prepared in proper proportions for application to the first panel. For example, a two-part epoxy (e.g., Epo-Tek 301-2, Epoxy Technology, Inc., Billerica, Mass., USA) may be mixed in proper amounts of epoxy and hardener (e.g., 75 ml. Epoxy & 25 ml. Hardener) and, then, placed in an air/bubble removal device to remove air from the mixture (block 122). Accordingly, the epoxy mixture can be placed in a bell jar under vacuum and agitated for a time sufficient to diminish the bubbles (e.g., 15 minutes for an epoxy with a pot life of several hours). If the epoxy mixture is not properly mixed and prepared (blocks 120 & 122), then the bonding and optical qualities may be adversely impacted. The materials can also be index matched, if possible, to provide optimal lighting and optical qualities.

For each bond between first and second panels, the bonding technique 114 comprises applying or pouring the epoxy mixture onto one half of the first panel surface (block 124), and allowing or procuring relatively uniform distribution of the epoxy mixture over the half (e.g., the left or right half of the first panel). To avoid bubble formation, the epoxy mixture may be applied by continuously pouring it onto the one half (e.g., without dripping or inducing irregular flow of the epoxy mixture). The second panel is then aligned with the edge of epoxy on the one half of the first panel (block 126) in the desired edge location for permanent bonding of the first and second panels. The second panel is applied to the first panel by contacting the second panel at the alignment edge (block 126), rotating the second panel about the alignment edge, pressing the second panel onto the epoxy mixture distributed on the half of the first panel, forming a wedge between the first and second panels, and causing the epoxy mixture to flow and distribute across the surface of the first panel as the second panel is rotated and pressed (e.g., like a hinge) onto the first panel (block 128). Accordingly, the bonding technique 114 applies the second panel to the first panel by wetting the surfaces between the first and second panels, and by flowing and distributing the epoxy mixture smoothly between the panels to avoid bubble formation. This “wedge” technique avoids bubble formation that could result from direct application of the first and second panels, and it forces excess epoxy mixture out at the edges of the first and second panels. If the second panel is not rigid, then the bonding technique may still proceed in a wedge-like manner, but it may require a device (e.g., a roller or wide flat headed tool) to facilitate an even application of the second panel onto the first panel. A roller, smooth scraper, or other flat-headed device may then be used to provide a uniform epoxy thickness between the first and second panels (block 130). For example, a roller may be applied to the outer surface of the second panel, rolling consistently across the outer surface to distribute the epoxy and to force excess epoxy out of the bond area between the first and second panels. Excess epoxy can then be removed from the areas surrounding the first and second panel bond (block 132).

To bond the diffuser sheet 106 to the liquid crystal display 16, the bonding technique 114 comprises applying the epoxy mixture onto one half of the surface within the dam around the liquid crystal display 16 (block 124), and allowing or procuring relatively uniform distribution of the epoxy mixture over the one half. To avoid bubble formation, the epoxy mixture may be applied by continuously pouring it onto the one half. The diffuser sheet 106 is then aligned with the edge of the epoxy mixture on the one half of the liquid crystal display 16 (block 126) in the desired edge location for permanent bonding of the diffuser sheet 106 to the liquid crystal display 16. The diffuser sheet 106 is applied to the liquid crystal display 16 by contacting the epoxy mixture at the alignment edge (block 126), rotating the diffuser sheet 106 about the alignment edge, pressing the diffuser sheet 106 onto the epoxy mixture distributed on the one half of the liquid crystal display 16, forming a wedge between the surfaces of the diffuser sheet 106 and the liquid crystal display 16, and causing the epoxy mixture to flow and distribute between the surfaces as the diffuser sheet 106 is rotated and pressed (e.g., like a hinge) onto the liquid crystal display 16 (block 128). Accordingly, the bonding technique 114 applies the diffuser sheet 106 to the liquid crystal display 16 by wetting the surfaces with the epoxy mixture and by smoothly flowing and distributing the epoxy mixture between the surfaces to avoid bubble formation. The epoxy thickness, or bond thickness, between the diffuser sheet 106 and the liquid crystal display 16 is then made uniform using a suitable device (block 130). Excess epoxy can then be removed from the surrounding areas (block 132).

If another bond is desired (block 134), then the bonding technique may be repeated (or partially repeated) to form a multi-bond-layer structure such as illustrated in FIG. 4. If additional preparation or epoxy is required, then the bonding technique 114 may begin by preparing additional panels for bonding (block 118) and mixing and preparing additional epoxy (blocks 120 & 122). Accordingly, the second iteration bonds the transparent panel 108 (e.g., glass panel with matte AR surface) to the diffuser sheet 106, which was bonded to the liquid crystal display 16 as described above. The epoxy mixture is continuously poured over one half of the diffuser sheet surface (block 124) and is allowed to settle over that one half surface to facilitate a substantially uniform thickness of epoxy. The transparent panel 108 is then aligned with the edge of epoxy for permanent bonding to the diffuser sheet 106. The transparent panel 108 is applied to the diffuser sheet 106 by contacting the epoxy mixture at the alignment edge (block 126), rotating the transparent panel 108 about the alignment edge and pressing the transparent panel 108 onto the epoxy mixture distributed on the one half of the diffuser sheet 106, forming a wedge between the diffuser sheet 106 and the transparent panel 108, and causing the epoxy mixture to flow and distribute between the surfaces of the diffuser sheet 106 and the transparent panel 108 as the transparent panel 108 is rotated and pressed onto the diffuser sheet 106 (block 128). Accordingly, the bonding technique 114 applies the transparent panel 108 to the diffuser sheet 106 by wetting the surfaces with the epoxy mixture and by smoothly flowing and distributing the epoxy mixture between the surfaces to avoid bubble formation. The epoxy thickness between the diffuser sheet 106 and the transparent panel 108 is then made uniform using a suitable device (block 130). Note also, that a sufficiently heavy second panel (e.g., the transparent panel 108) may cause the epoxy mixture to settle out naturally and to facilitate a uniform thickness prior to hardening of the epoxy mixture. Excess epoxy can then be removed from the surrounding areas (block 132).

Once the desired number of panels has been bonded, as described above, the epoxy mixture disposed between the panels is cured. Depending on the type of epoxy, as well as the proportions of hardener and epoxy in the mixture, the conditions for curing may vary. The technique may allow a choice of curing techniques (block 136), such as curing the epoxy mixture at room temperature (block 138) or accelerated/heated curing of the epoxy mixture (block 140). For example, the epoxy “Epo-Tek 301-2” may cure in approximately two days at room temperature, or it may cure overnight at 40° C. The selection also may impact the properties of the epoxy mixture, as finally cured, thus the selection may impact the optical quality of the bond. After selecting the type of cure (block 136), the technique proceeds to curing and clean-up (142). For example, the dam and any temporary masking and coverings may be removed from the surrounding areas, or from the outer surface of the transparent panel 108, before the epoxy mixture hardens and fixes the temporary coverings to the structure. After the curing is complete, the structure (e.g., the front portion 104) may be assembled, or reassembled, into the desired electronic device.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A display comprising:
a display screen;
a transparent panel having a backside and an anti-glare front surface configured to diffuse ambient light; and
a bulk diffuser disposed between the display screen and the backside, wherein the bulk diffuser is bonded to at least one of the display screen and the transparent panel, and the bulk diffuser is configured to diffuse image light of the display.

2. The system of claim 1, wherein the display screen comprises a liquid crystal display screen.

3. The system of claim 1, wherein the transparent panel comprises a glass panel.

4. The system of claim 1, wherein the transparent panel comprises a molded plastic panel.

5. The system of claim 1, comprising an anti-reflective layer disposed on the anti-glare front surface.

6. The system of claim 1, wherein the anti-glare front surface comprises a surface texture.

7. The system of claim 6, wherein the surface texture comprises a chemically etched surface texture.

8. The system of claim 6, wherein the surface texture comprises a mechanically ground surface texture.

9. The system of claim 6, wherein the surface texture comprises a molded surface texture.

10. The system of claim 6, wherein the bulk diffuser is configured to reduce undesirable optical effects caused by the surface texture.

11. The system of claim 1, wherein the bulk diffuser comprises a diffusive material configured to diffuse light within the diffusive material.

12. The system of claim 1, comprising an index-matched bond material disposed between the bulk diffuser and at least one of the display screen and the transparent panel.

13. The system of claim 12, wherein the index-matched bond material is substantially bubble-free.

14. The system of claim 12, wherein the index-matched bond material comprises an epoxy.

15. The system of claim 1, comprising bond layers disposed between the bulk diffuser and both of the display screen and the transparent panel.

16. A method for manufacturing a display having a display screen, the method comprising the acts of:
positioning a bulk diffuser between the display screen and an anti-glare front layer, wherein the bulk diffuser comprises a diffusive material configured to scatter light within the diffusive material; and
bonding the bulk diffuser to at least one of the anti-glare front layer and the display screen.

17. The method of claim 16, wherein the display screen comprises a liquid crystal display.

18. The method of claim 16, wherein the anti-glare front layer comprises a transparent panel.

19. The method of claim 18, wherein the transparent panel comprises a glass panel.

20. The method of claim 18, wherein the transparent panel comprises an anti-reflective coating.

21. The method of claim 18, wherein the anti-glare front layer comprises a surface texture configured to diffuse ambient light.

22. The method of claim 21, wherein the surface texture comprises a chemically etched surface texture.

23. The method of claim 21, wherein the surface texture comprises a mechanically ground surface texture.

24. The method of claim 21, wherein the surface texture comprises a molded surface texture.

25. The method of claim 21, comprising the act of:
coarsening the surface texture to enhance the performance of the anti-glare front layer.

26. The method of claim 25, wherein the act of positioning the bulk diffuser comprises the act of:
reducing color separation effects caused by the surface texture.

27. The method of claim 16, wherein the act of positioning the bulk diffuser comprises the act of:
reducing undesirable optical characteristics caused by the anti-glare front layer.

28. The method of claim 16, wherein the act of bonding comprises the act of:
bonding using an index-matched bond material.

29. The method of claim 16, wherein the act of bonding comprises the act of:
bonding using an epoxy.

30. The method of claim 16, wherein the act of bonding comprises the act of:
bonding the bulk diffuser to both the anti-glare front layer and the display screen.

31. The method of claim 16, wherein the act of bonding comprises the act of:
bonding the bulk diffuser to a light control layer disposed adjacent one of the anti-glare front layer and the display screen.

32. The method of claim 16, comprising the acts of:
positioning a plurality of elongated lamps behind the display screen; and
positioning a reflector panel behind the plurality of elongated lamps.

33. The method of claim 32, comprising the act of:
positioning a diffuser screen between the display screen and the plurality of elongated lamps.

34. The method of claim 32, comprising the act of:
positioning a plurality of light control layers between the display screen and the plurality of elongated lamps.

35. A method of forming a display, the method comprising the acts of:
flowing a bond material onto a side portion of a bond surface of a first layer of a plurality of display layers;
aligning a feature of a second layer of the plurality of display layers with a feature of the first layer to form a junction;
rotating and pressing the second layer onto the first layer starting from the junction and proceeding evenly across the second layer to form a substantially uniform bond layer of the bond material between the first and second layers; and
curing the bond material.

36. The method of claim 35, comprising the act of:
preparing a surface of one of the plurality of display layers for bonding.

37. The method of claim 35, comprising the act of:
preparing the bond material.

38. The method of claim 37, wherein the act of preparing the bond material comprises the act of:
mixing components of an epoxy.

39. The method of claim 37, wherein the act of preparing the bond material comprises the act of:
removing bubbles from the bond material.

40. The method of claim 37, wherein the act of preparing the bond material comprises the act of:
agitating the bond material in a vacuum environment.

41. The method of claim 35, wherein the act of flowing the bond material comprises the act of:
continuously flowing the bond material.

42. The method of claim 35, comprising the acts of:
forming a dam around the first layer to contain the bond material; and
forming a substantially uniform layer of the bond material on the side portion.

43. The method of claim 35, wherein the first layer comprises a display screen and the second layer comprises a diffusion layer, the diffusion layer comprising a diffusive material configured to diffuse light within the diffusive material.

44. The method of claim 43, wherein the display screen comprises a liquid crystal display.

45. The method of claim 35, wherein the first layer comprises a diffusion layer and the second layer comprises an anti-glare panel, the diffusion layer comprising a diffusive material configured to diffuse light within the diffusive material and the anti-glare panel comprising a textured surface configured to diffuse ambient light.

46. The method of claim 45, comprising the act of:
coarsening the textured surface to enhance the performance of the anti-glare front layer.

47. The method of claim 46, comprising the act of:
providing a desirable type and thickness of the diffusive material to reduce color separation effects caused by the textured surface.

48. The method of claim 45, comprising the act of:
coarsening the textured surface to increase ambient light diffusion by the anti-glare panel;
providing the diffusion layer to increase image light diffusion for reducing undesirable effects caused by the anti-glare panel; and
balancing characteristics of the textured surface and the diffusion layer to provide a desirable ambient light diffusion and to provide a desirable image quality.

49. The method of claim 43, comprising the acts of:
flowing the bond material onto a portion of a surface of the diffusion layer;
aligning an anti-glare panel with the diffusion layer to form a bond junction, wherein the anti-glare panel comprises a textured surface configured to diffuse ambient light; and
rotating and pressing the anti-glare panel onto the diffusion layer starting from the junction and proceeding evenly across the diffusion layer to form a substantially uniform bond with the bond material between the diffusion layer and the anti-glare panel.

50. The method of claim 35, comprising the acts of:
applying pressure to the second layer using a flat-headed device; and
sliding the flat-headed device between opposite edges of the second layer in a substantially parallel orientation relative to the opposite edges.

51. The method of claim 35, comprising the acts of:
forming a wedge between the first and second layers; and
evenly pressuring the wedge to flow the bond material between the first and second layers.

52. The method of claim 51, wherein the act of evenly pressuring the wedge comprises the act of:
steadily pressuring the bond material to flow substantially bubble free.

53. The method of claim 35, comprising the act of:
index matching the bond material with the plurality of display layers.

54. The method of claim 35, comprising the acts of:
positioning a plurality of elongated lamps behind the first layer, the first layer comprising a display screen; and
positioning a reflector panel behind the plurality of elongated lamps.

55. The method of claim 35, comprising the act of:
forming a multi-layered bonded display structure comprising the plurality of display layers.

56. The method of claim 55, comprising the act of:
retrofitting the multi-layered bonded display structure into the display.

57. The method of claim 35, wherein the act of curing comprises the act of:
heating the bond material for a desired cure time.
